(19) United States
(12) Patent Application Publication
(10) Pub. No.: US 2025/0178434 A1
(43) Pub. Date: Jun. 5, 2025

(54) METHOD FOR CONVERTING A VEHICLE, METHOD FOR PROVIDING A DRIVE UNIT, DRIVE UNIT AND VEHICLE

(71) Applicant: DINTEC GMBH, Kaufbeuren (DE)

(72) Inventor: Michael Philipp SCHMITT, Kaufbeuren (DE)

(21) Appl. No.: 18/836,959

(22) PCT Filed: Sep. 18, 2023
(86) PCT No.: PCT/DE2023/200191

§ 371 Date: Aug. 8, 2024

(30) Foreign Application Priority Data
Sep. 19, 2022 (DE) 10 2022 123 918.7

(51) Int. Cl. B60K 17/28; B60L 1/00; B63B 79/40; B63H 21/17; B63H 23/04; B63J 3/02

(52) U.S. Cl. CPC B60K 17/28; B60L 1/003; B63B 79/40; B63H 21/17; B63H 23/04; B63J 3/02

(57) ABSTRACT

A method for converting a vehicle by exchanging its drive unit from an internal-combustion drive principle to an electrically operated drivetrain, whereby the drive unit with at least one electrically operated motor is provided as a replacement unit, whereby the replacement unit (i) is spatially compatible with the available installation space of the removed drive unit with an internal-combustion engine, (ii) is mechanically compatible with the interfaces and (iii) behaves functionally identically at all interfaces. The invention follows the form-fit-function idea and thus enables extremely rapid market access for converted vehicles because they can continue to use existing parts approvals for the largest possible part of their components, thus making new approval tests unnecessary as far as possible.

The invention involves a method for converting a vehicle, a method for providing a drive unit, a drive unit and a vehicle.

From the state of the art, there is a known method for converting a vehicle by changing its drive unit from an internal-combustion drive principle to an electrically operated drivetrain, whereby a vehicle for an internal-combustion drive principle has a drive unit with an internal-combustion engine or one for an electrically operated drivetrain has a drive unit with an electrically operated motor, whereby the vehicle belongs to the group of commercial vehicles, special vehicles, mobile work machines and watercraft, whereby the drive unit with an internal-combustion engine has a crankshaft for generating rotary movements and at least one power take-off for transmitting the rotary movements to a drivetrain of the vehicle, and at least one drive-independent internal power take-off for transmitting rotary movements of the shaft to auxiliary units mounted directly on the internal-combustion engine for operation of basic functions of the vehicle and optionally one or more further auxiliary power take-offs for direct mechanical operation of external units for additional functions of the vehicle (e.g., vehicle bodies), with the following steps: The drive unit with an internal-combustion engine is mechanically separated from the vehicle and optionally present structures, and the drive unit with an internal-combustion engine and the remaining connected auxiliary units is removed from the vehicle, and a drive unit is provided with at least one electrically operated motor, whereby a shaft for transferring rotary motion, and at least one power take-off for transferring the rotary motion to the drivetrain of the vehicle, and an electrically operated replacement of the auxiliary units independent of the main drive, which may be new, electrically operated auxiliary units or at least partially the removed mechanically operated auxiliary units with an additional electrically operated motor, and the drive unit with an electrically operated motor is installed in the vehicle instead of the drive unit with an internal-combustion engine together with independent replacement of the auxiliary units and mechanical mounts and effectively coupled by adapters to the drivetrain of the vehicle, and the independently electrically operated replacement of the auxiliary units is coupled to the vehicle through additional or adapted connection cables to compensate for the positioning of the new auxiliary units compared to the original state.

The invention is based on the objective of providing an improvement or an alternative to the state of the art.

According to a first aspect of the present invention, the set task is solved by a method of converting a vehicle
by changing its drive unit from an internal-combustion drive principle to an electrically operated drivetrain,
whereby a vehicle for an internal-combustion drive principle has a drive unit with an internal-combustion engine, and whereby a vehicle or an electrically operated drivetrain has a drive unit with an electrically operated motor,
whereby the vehicle belongs to the group of commercial vehicles, special vehicles, mobile work machines and watercraft,
whereby the drive unit with an internal-combustion engine has
   a crankshaft for generating rotary motion driven by a core engine, and
   at least one main power take-off for transferring the rotary motion to a drivetrain of the vehicle, and
   at least one internal power take-off for transferring the rotary motion to unit-internal auxiliary units, and
   optionally at least one drive-independent auxiliary power take-off to transfer the rotary motion to external units,
whereby the method of converting comprises the following steps:
a. the drive unit with an internal-combustion engine is mechanically separated from the vehicle as follows:
   i. Main power take-off: the coupling between the main power take-off and the drive gear is released.
   ii. Internal drives connecting the core engine and the auxiliary units: the connection between the auxiliary units and their connections to the rest of the vehicle, such as to respective auxiliary media, such as compressed air, hydraulics, steering assist, 24V onboard power supply, etc., is disconnected.
   whereby the auxiliary units remain at least partially, preferentially completely, on the unit.
iii. Auxiliary power take-offs: if auxiliary power take-offs are present that lead to external units, they will also be disconnected.
iv. Other connections: all other mechanical, thermal and electro-mechanical connections are unfastened, such as screw joints; hoses and plugs, especially including control connections and the power supply;
   so that the drive unit with an internal-combustion engine and the connected auxiliary units are removed from the vehicle and disconnected at a number of interfaces;
b. the drive unit with at least one electrically operated motor is provided as a replacement unit, whereby the replacement unit
   i. is spatially compatible with the available installation space of the removed drive unit with an internal-combustion engine,
   ii. is mechanically compatible with the interfaces and
   iii. behaves functionally identically at all interfaces, i.e., at main power take-offs, connections between the auxiliary units and the rest of the vehicle and the optional auxiliary power take-offs.

Conceptually, it should be explained that the identical behavior at the interfaces is to be understood as at the main power take-offs, connections between the auxiliary units and the rest of the vehicle and the optional auxiliary power take-offs.

The presented aspect of the invention can be summarized in technical jargon as form-fit and functional compatibility:

The first requirement is that the shape of the replacement unit must fit into the available space of the removed internal-combustion unit.

This means in particular that the new unit should ideally not exceed the space of the previous unit at any point. In this simplest case, there is no doubt that the new unit can be inserted into the space of the old unit.

Any displacement or bending of movable elements in the installation space, such as cables, cable harnesses or hoses, should be understood as available, free installation space. What is crucial is that components of the rest of the vehicle do not have to be modified so that they interact in a new way, because this may require a new authorization of the rest of the vehicle.

However, the new unit may also require a larger installation space overall or in different places than the previous unit. This always depends on the specific space available in the vehicle.

However, at the same time, the second requirement must be met, specifically the mechanical fit.

This means that it must be possible to use existing mechanical connection points. For example, there are holes as mechanical mounting points into which the unit is suspended and secured in the installation space and the kinetic work is transferred using screw joints and, if necessary, rivets. It must be possible to adequately secure the unit using the mounting points available on the vehicle. Adapters can also be part of the new unit; it is not absolutely necessary for the new unit to be designed in one piece up to the mounting points. Ideally, however, the new unit, with or without adapters, uses all of the mounting points of the previous unit to the rest of the vehicle.

Not all mechanical connection points need to be used. This means that some existing mechanical connection points may remain unused after the vehicle has been converted, for example because the replacement unit is smaller and/or lighter than the original unit.

The third requirement is the function:

There are various connections between a unit and the rest of the vehicle. In particularly, these can be mechanical, thermal and electro-mechanical connections. Since all physical connections are disconnected during removal (any wireless connections for data cannot be mechanically disconnected, but nonetheless form interfaces), the vehicle and its control system anticipate that the replacement unit will operate all interfaces again. This is understood as functional compatibility.

Therefore, for mechanical functional compatibility, crankshaft emulation must be provided. According to the current assessment of the invention, it is necessary to replace the crankshaft, either with an electrically driven crankshaft (in which case it can theoretically be taken from the original unit) or preferentially with a replacement shaft.

In the new replacement unit: The original auxiliary units are preferentially used. These are operated by the internal power take-offs. The original auxiliary units are attached to the original transfer gears. The transfer gears were originally driven by the crankshaft, and are therefore driven by the replacement shaft after conversion.

This therefore directly affects media handling. If, for example, the original unit has a water pump for a coolant water circuit, then the control system of the rest of the vehicle anticipates the pump to continue running and flushing the coolant even after the conversion, even if there is no longer an internal-combustion engine to be cooled. For example, water can still be circulated. This has the side effect of allowing an electric battery to be cooled, but more importantly, it means that water is present in a thermal fluid circuit at such a pressure that the rest of the vehicle can record all measured values within the limits anticipated by the control system. To further explain the example, if the driver's cab of the vehicle requests hot water heated by the engine, such as to provide warm heating air for the driver's cab, the replacement unit preferentially provides an electric heater or post-heater to also transfer the thermal medium to the rest of the vehicle in a value range that is expected by the rest of the vehicle, such as in a range of 80° C. to 120° C. For this, the replacement unit preferentially captures data with sensors and uses the data itself without directing it through the main bus to the rest of the vehicle. It is therefore conceivable that the replacement unit with its control device records the actual coolant water temperature, which can be between 10° C. and 50° C., for example, and then reports the value expected from the rest of the vehicle to the bus system as a fictitious value if the rest of the vehicle requests this temperature, but uses the actual value for its own control, for example, to provide the power of the post-heating for the requested hot water line to the driver's cab or for its ventilation to the required extent.

Another example can be the air compressor, which provides the compressed air for the vehicle's compressed air brake system.

The suggested functional compatibility also expressly extends to data: the replacement unit preferentially has its own control device, which, based on the data structure in the vehicle's electronic bus system, enters data into the bus system when and to the extent that the rest of the vehicle anticipates this data.

An optional aspect of the invention can also be described as a method for converting a vehicle by exchanging its drive unit from an internal-combustion drive principle to an electrically operated drivetrain, whereby a vehicle for an internal-combustion drive principle has a drive unit with an internal-combustion engine, and whereby a vehicle for an electrically operated drivetrain has a drive unit with an electrically operated motor, whereby the vehicle belongs to the group of commercial vehicles, special vehicles, mobile work machines and watercraft, whereby the drive unit with an internal-combustion engine has a crankshaft for generating rotary movements and at least one power take-off for transmitting the rotary movements to a drivetrain of the vehicle, and at least one drive-independent internal power take-off for transmitting rotary movements of the shaft to auxiliary units, and optionally at least one auxiliary power take-off for transmitting the rotary movement of the shaft to external units, with the following steps:
a. the drive unit with an internal-combustion engine is mechanically separated from the vehicle and optional existing structures, and b. the drive unit with an internal-combustion engine is removed from the vehicle, including in particular all remaining connected auxiliary units, and c. the drive unit with at least one electrically operated motor is provided as a replacement unit,
whereby the drive unit has a shaft for transmitting rotary movements, and at least one power take-off for transmitting the rotary movements to the drivetrain of the vehicle, and at least one drive-independent power take-off for transmitting rotary movements of the shaft to auxiliary units, as well as a drive engagement of the electrically operated motor to the shaft; and
d. the drive unit with an electrically operated motor is operatively coupled to auxiliary units that correspond at least in part to the auxiliary units of the drive unit with an internal-combustion engine, and e. the drive unit with an electrically operated motor is installed in the vehicle instead of the drive unit with an internal-combustion engine, and f. the drive unit with an electrically operated motor is mechanically operatively coupled to the drivetrain of the vehicle and optional existing structures, and g. the operatively connected external units are coupled to the vehicle,
whereby the drive unit with an internal-combustion engine has at least one drive-independent auxiliary power take-off for transmitting rotary movements of the shaft for work functions, and
whereby the drive unit with an electrically operated motor is coupled to the minimum of one drive-independent power take-off for transmitting rotary movements of the shaft for work functions.

The concept is explained as follows:

The engine has two or (often) three different power take-offs.
The “main power take-off” is coupled to the drive gear and serves to drive the vehicle or can be used for other work functions through an optional intermediate gear.
One or more “internal power take-offs” drive the “auxiliary units”. The auxiliary units handle the vehicle's internal functions. For example, they drive the air compressor of the compressed air brake system.
One or more “auxiliary power take-offs” drive the optional external units. In vehicles of the type involved here, external units are usually, but not necessarily, found in the bodies of the vehicles. For example, they drive the hydraulic pumps for a tilting device.

The described aspect of the invention is therefore based on a method for converting a vehicle by changing its drive unit from an internal-combustion drive principle to an electrically operated drivetrain, whereby a vehicle for an internal-combustion drive principle has a drive unit with an internal-combustion engine or for an electrically operated drivetrain has a drive unit with an electrically operated motor, whereby the vehicle belongs to the group of commercial vehicles, special vehicles, mobile work machines and watercraft, whereby the drive unit with an internal-combustion engine has a crankshaft for generating rotary movements and at least one power take-off for transmitting the rotary movements to a drivetrain of the vehicle, and at least one drive-independent internal power take-off for transmitting rotary movements of the shaft to auxiliary units mounted directly on the internal-combustion engine for the operation of basic functions of the vehicle and optionally one or more further auxiliary power take-offs for the direct mechanical operation of external units for additional functions of the vehicle (e.g., vehicle bodies), with the following steps:

The drive unit with an internal-combustion engine is mechanically separated from the vehicle and optional existing structures, and the drive unit with an internal-combustion engine is removed from the vehicle together with the remaining operatively connected auxiliary units coupled to it. A drive unit is provided with at least one electrically operated motor (which has a shaft for transmitting rotary movements and at least one power take-off for transmitting the rotary movements to the drivetrain of the vehicle) and an electrically operated replacement of the auxiliary units independent of the main drive, which can be new, electrically operated auxiliary units or at least partially the removed mechanically operated auxiliary units with an additional electrically operated motor.

The drive unit with an electrically operated motor is installed in the vehicle together with the independent replacement of the auxiliary units with mechanical mounts instead of the drive unit with an internal-combustion engine.

The new drive unit can be effectively coupled by adapters to the vehicle's drivetrain.

After installation of the drive unit with an electrically operated motor, it is possible that many locations will require adapters. An adapter can be used for mechanical, thermal and/or electro-mechanical adaptation. For example, such an adapter can be designed for thermal adaptation using an additional connection cable or by adapting a connection cable already present. The adapter has the function of creating compensation if one of the new auxiliary units has a different installation position compared to the original state, i.e. the position that the auxiliary unit had in the drive unit with an internal-combustion engine.

The presented aspect of the invention therefore proposes that the drive unit with an electrically operated motor replace the drive unit with an internal-combustion engine in such a way that no changes to the vehicle are required for mechanical integration of the electrically operated drive unit, the existing connection points for fastening continue to be used unchanged and all functions provided by the drive unit with an internal-combustion engine are passed on unchanged at all interfaces to the vehicle. The invention is therefore realized through form-fit and functional compatibility.

No changes to the vehicle during mechanical integration means that the electrically operated drive unit advantageously uses, at least essentially, only the available installation space (engine tunnel) without any modifications to the vehicle being necessary.

The continued use of the existing mechanical connection points can include, in particular, the mounts and fastening points for mounting the drive unit in the vehicle, the connections for fastening the drive unit to the drivetrain's drive gear, the optionally available mechanical connections for external units (driven by the auxiliary power take-offs), the mechanical connections of the auxiliary units operatively connected to the drive unit to the connection points of the vehicle's auxiliary media (e.g., compressed air, power steering hydraulics, on-board power supply, etc.), and/or the electromechanical interfaces to the vehicle's on-board power supply.

The functional compatibility of the interfaces of the electrically operated drive unit with the combustion engine-operated drive unit can include, in particular, the behavior of the main power take-off and the optional auxiliary power take-offs, the functional behavior of the auxiliary media and the control interfaces between the vehicle and the drive unit.

The process is preferentially used to create electrically powered vehicles from existing new or used vehicles fitted with combustion engines (retrofitting process). Due to the form, fit and functional compatibility of the electrically operated drive unit, the conversion work is limited to replacing the unit, installing the electrical energy source (batteries and/or fuel cells and/or internal-combustion range extenders) and the approval activities required for the conversion under traffic law to prove functional compatibility at the interfaces of the unit. Existing approvals for comprehensive vehicle functions, such as the compressed air brake, can thus be achieved with minimal effort.

An alternative preferential application of the process is in the production of new electrically powered vehicles by using existing production processes and existing production infrastructure for vehicles with combustion engines. For this purpose, in the vehicle without a drive unit (gliding chassis), the electric drivetrain with the electrically operated drive unit is installed in the production step for installing the drive unit instead of the internal-combustion drivetrain. Due to the functional compatibility of the drive unit, the resulting electric vehicle is also functionally compatible with the vehicle powered by an internal-combustion engine. The production steps downstream of the installation of the drivetrain can continue to be used unchanged (brake test benches, etc.). This enables series production with minimal effort through the compatibility of the resulting vehicle with the existing production infrastructure.

Mobile work machines are understood to mean, in particular, self-propelled, towed or relocatable machines with an integrated drive unit whose main application is outside public road traffic and with or without the necessary road approval. In particular, a mobile work machine can be a construction machine, an agricultural machine, multifunctional vehicles (equipment carriers), machines for transport and cargo handling, for goods handling, in depots, ports or airports, machines from the fields of mining, forestry, municipal tasks or military applications. Commercial vehicles are understood to mean, in particular, all road vehicles which, by their equipment and design, are designed for the purpose of transporting people, transporting loads and goods and/or to tow trailers or semi-trailers. In particular, commercial vehicles include trucks with or without a body, both as front-wheel-drive and as short- or long-hood trucks. Special vehicles are understood to be road vehicles for special purposes which are not used solely for the transport of goods. This includes in particular, but not exclusively, emergency vehicles (e.g., fire fighters, police, rescue service, etc.), crane trucks, skip loaders, roll-off dumpers, refuse collection vehicles, sewer cleaning vehicles, road sweepers, swap body lift trucks, winter service vehicles, dump trucks and cement mixers, truck-mounted concrete pumps or suction excavators.

Preferentially, the main power take-off is designed to transmit the rotary movements to a drivetrain of the vehicle. In particular, the main power take-off can be connected to the transmission of the drivetrain outside the drive unit. In an alternative implementation, the main drive can additionally be designed to operate a hydrodynamic brake.

Preferentially, an optionally available drive-independent auxiliary power take-off is designed to operate optional external units of the attachments or structures. The drive-independent auxiliary power take-off can be referred to as an engine-dependent or flywheel-side auxiliary power take-off. The drive-independent auxiliary power take-off can be designed to enable, in particular to drive, functions of the vehicle that do not serve the driving operation of the vehicle, whereby the functions can be implemented, for example, by structures or attachments to the vehicle.

Preferentially, the electrically operated drive unit is implemented by replacing the combustion area with crankshaft (combustion-operated core engine with engine block, cylinder, etc.) of the internal-combustion drive unit with an electro-mechanical replacement construction (electrically operated core engine), including a replacement shaft for crankshaft emulation. The mechanics of the electrically operated core engine replicate the mechanical properties of the combustion-operated core engine, for example the mechanical support structure, the mounting surfaces for the other parts of the drive unit (connection surfaces and connection points for auxiliary units, brackets, housing parts, bearings for internal gear parts of the drive unit and bearings of the shaft) and provides the mechanical mounting points for the electrical components. The electrically operated core motor includes at least one electrically operated motor, which is attached to the mechanical support structure and is operatively connected to the replacement shaft via an integrated motor gear.

The integrated motor gear can, for example, be adapted to the speed of the electrically operated motor by means of a transmission or a reduction ratio.

An offset can be provided between the electrically operated motor and the shaft. In particular, the electrically operated motor and the shaft can be arranged offset.

Summation can be provided for several electrically operated motors. In particular, several electrically operated motors can be coupled by a summing gear.

The replacement shaft of the electrically operated core motor should be identical to the crankshaft of the internal-combustion drive unit in terms of mechanical design and positioning in the bearing area and the connection areas. In areas other than the bearing and connection areas, the replacement shaft may, but does not have to, be designed differently than the originally intended crankshaft. Above all, the shape of the replacement shaft should be simplified compared to a crankshaft, which is free of crank pins and crank webs.

In a further step, the electrically operated core motor is supplemented with the other parts of the drive unit to form the electrically operated drive unit. This includes housing parts, engine mounts, auxiliary units and one or more internal transfer gears to drive the attached auxiliary units as well as the optional auxiliary power take-off.

The other parts of the drive unit, in particular the housing parts, engine mounts, auxiliary units, transfer gears, optional auxiliary drives, can each be replaced with new parts, preferentially of identical construction. The parts may be the same, or new, or partially new.

The mechanical design can offer the same connection surfaces, connection points and spatial positioning as the internal-combustion drive unit.

The auxiliary units are operated by the replacement shaft through transfer gears. For this purpose, the same transfer gears and drive shafts as in the internal-combustion drive unit can preferentially be used.

For this, the mechanical design can offer the identical connection surfaces, connection points and spatial positioning of the bearings and transmission parts as the internal-combustion drive unit.

The optional auxiliary power take-offs for the direct mechanical operation of external units for additional functions of the vehicle (e.g., vehicle bodies) are also operated through the transfer case from the replacement shaft. For this purpose, the same transfer gears and drive shafts as in the internal-combustion drive unit can preferentially be used.

For this, the mechanical design can offer the identical connection surfaces, connection points and spatial positioning of the connection of the external units as the internal-combustion drive unit.

Furthermore, the electrically operated drive unit includes an electronic control system that controls the electrically operated motors and the other electrical components of the drive unit, provides the interface for controlling the drive unit through the higher-level vehicle control system and can exchange data with components of the vehicle through the interface and the vehicle data network (e.g., CAN bus system).

The control system includes a control application that interprets the control commands of the vehicle and controls the electrically operated motor, taking into account the properties of the internal engine transmission, in such a way that an operating state of the replacement shaft is established that corresponds to the identical operating state of the crankshaft of the internal-combustion drive unit with the same control on the vehicle side (i.e., crankshaft emulation is realized using the replacement shaft). This results in functionally compatible behavior at the main power take-off of the electrically operated drive unit.

If the electrically operated drive unit is implemented by using the described identical transfer gear and the auxiliary units of the internal-combustion drive unit, the replacement crankshaft emulation also inherently ensures the functionally compatible operation of the auxiliary units and thus the functionally compatible provision of the auxiliary media provided by the auxiliary units (compressed air, power steering hydraulics, etc.) (functional emulation of the auxiliary media).

The control system includes a control application that comprehensively generates the drive unit data expected by the higher-level vehicle control system and sends it though the control interface in the expected format (restbus emulation). The generated data includes real data (e.g., the crankshaft speed), data that is reinterpreted in the context of the technology change for the continued use of higher-level functions (e.g., use of the fuel gage to display the charge level of the traction battery), and fictitious data that is no longer available due to the technology change to electric drive, but is expected by the higher-level system for error-free operation (e.g., fill level of the AdBlue tank. The restbus emulation enables error-free operation of the electrically operated drive unit without changes to the higher-level vehicle control system.

According to a second aspect of the present invention, the set task is achieved by a method for converting a vehicle by replacing its drive unit from an internal-combustion drive principle to an electrically operated drivetrain,
whereby a vehicle for an internal-combustion drive principle has a drive unit that has an internal-combustion engine as the core engine, a plurality of gear-driven auxiliary units and a shaft drive, or whereby the vehicle for an electric drive principle has a drive unit with an electrically operated core engine,
whereby the vehicle belongs to the group of commercial vehicles, special vehicles, mobile work machines and watercraft.

It is proposed that the drive unit be removed, the internal-combustion component (core engine with engine block, cylinders, etc.) be removed, the electrically operated core engine be installed instead, the auxiliary units be left at least partly identical and at least partly connected to the gear transmission, and that the drive unit modified in this way be installed in the vehicle.

This uses a mechanical replacement design that enables optimal reusability of existing transfer gears.

Preferentially, the method is designed as a retrofit method, in particular as a retrofit conversion method.

Preferentially, the drive unit comprises at least one output for an auxiliary unit. Advantageous reuse of vehicle components can be achieved. In particular, the components can continue to be used without the need for recertification.

According to a third aspect of the invention, the stated object is achieved by a method for providing a drive unit with an electrically operated motor for a vehicle from the group of commercial vehicles, special vehicles, mobile work machines and watercraft, which can be installed instead of a drive unit with an internal-combustion engine, whereby
the drive unit has a shaft that is designed to act in the same way as a crankshaft of a drive unit with an internal-combustion engine for transmitting rotary movements, whereby
the drive unit has
   at least one main power take-off for transferring the rotary motion to a drivetrain of the vehicle, and
   at least one internal power take-off for transferring the rotary motion to unit-internal auxiliary units, and
   optionally at least one drive-independent auxiliary power take-off to transfer the rotary motion to external units,
whereby the drive unit has an electrically operated motor for driving the shaft, and
the drive unit has an engine mount for attaching the drive unit to the vehicle, which is identical to an engine mount of a drive unit with an internal-combustion engine, and
the drive unit has mechanical connections for attaching the drive unit to a transmission of the vehicle's drivetrain, which connections are identical to those of a drive unit with an internal-combustion engine in terms of fit, and
the drive unit has dimensions that at least substantially correspond to the dimensions of a drive unit with an internal-combustion engine.

In conceptual terms, it should be explained that compliance should “substantially” be met if the outer limits of the former drive unit with an internal-combustion engine are preferentially not exceeded, but in any case are at least predominantly exceeded by less than one decimeter, preferentially by less than 5 cm.

According to a fourth aspect of the invention, the set task is achieved by a method for converting a vehicle by replacing its drive unit from an internal-combustion drive principle to an electrically operated drivetrain,
whereby a vehicle for an internal-combustion drive principle has a drive unit with an internal-combustion engine or for an electrically operated drivetrain has a drive unit with an electrically operated motor,
whereby the vehicle belongs to the group of commercial vehicles, special vehicles, mobile work machines and watercraft,
whereby the vehicle has a control system by means of which components of the vehicle can exchange data with each other through a network,
whereby a control and communication unit is integrated into the network, receives data from other components of the vehicle and provides data that is read out and/or processed by communication units present in the vehicle.

According to a fifth aspect of the present invention, the set task is achieved by an electrically driven drive unit for installation into a vehicle from the group of commercial vehicles, special vehicles, mobile work machines and watercraft, whereby
the drive unit has a shaft for transferring rotary movements, and
the drive unit has an electrically operated motor to drive the shaft,
whereby the drive unit has
   at least one main power take-off for transferring the rotary motion to a drivetrain of the vehicle, and
   at least one internal power take-off for transferring the rotary motion to unit-internal auxiliary units, and
   optionally at least one drive-independent auxiliary power take-off to transfer the rotary motion to external units.

Preferentially, the drive unit with an internal-combustion engine has at least one drive-independent auxiliary power take-off for transferring rotary movements of the shaft for work functions.

It is proposed that the auxiliary power take-off be designed as a live power take-off that is directly or indirectly connected to the shaft and whose speed is directly correlated with a speed of the shaft, and/or the auxiliary power take-off is designed as a transmission power take-off that is connected to the shaft via a transmission so that the speed of the transmission power take-off can be varied at the same speed of the shaft, and/or the drive unit has a unit operation for transferring the rotary movements to at least one external unit.

It is conceivable that the unit operation has a roller for transferring the rotary movements to a belt and/or to a timing chain, and by means of the belt and/or the timing chain at least one auxiliary unit is indirectly driven by the electric motor.

According to the inventors' considerations, the minimum of one auxiliary unit can be a unit from the group consisting of a generator, hydraulic pump, power steering pump, water pump, air conditioning compressor, alternator, lubricant pump, coolant pump, metering pump, fan, compressed air generator, brake booster, hydrodynamic continuous brake, electrodynamic continuous brake, vacuum pump and rudder system of a watercraft.

The nominal speeds are preferentially standardized. In particular, the two standard speeds of 540 rpm and 1,000 rpm can be reduced in such a way that they are achieved in the range of the engine's rated speed, in particular maximum power. For some time now, there have also been speeds called 540E and 1000E (Economy), where the rated speed of the power take-off is reached at a reduced engine speed, usually close to the highest engine torque at around 1,400 rpm to 1,600 rpm. This makes it particularly advantageous to operate devices with low power consumption in an energy-saving manner.

In the case of a watercraft, the drive unit can operate a mechanical or hydraulic rudder system.

Furthermore, it is proposed that the drive unit has a drive lubrication system to reduce friction between moving drive parts.

Furthermore, it is proposed that the drive unit has a drive lubrication system to dissipate heat from bearing points.

Furthermore, it is proposed that the drive lubrication be connected to lubrication of a transmission that is operatively connected to the drive unit.

Furthermore, it is proposed that the drive unit has a control and communication unit that provides data that is interpreted as measured values by communication units present in the vehicle.

It is understood that the control and communication unit can be arranged within the installation space of the removed internal-combustion unit, but can also be arranged separately, such as in a separate housing.

In conceptual terms, it should be explained that the “provision” of data is to be understood in such a way that the control and communication unit does not receive at least part of the data that are interpreted as measured values by the existing communication units as measured values. It can collect data other than measured values via sensors, but at least in part it is intended to transmit values specified by the system as data, in a sense as alleged measured values.

Data may be obtained in the form of constant values and/or in the form of values obtained by sensory means and/or in the form of values obtained by sensory means and then converted and/or in the form of calculated values and then provided as alleged measured values.

The alleged measured values should be used at least predominantly for those quantities for which the sensors were removed when the combustion engine unit was removed. For example, since no such measured variables are available at all as a result of the change from the internal-combustion drive principle to the electrically driven drivetrain.

Specifically, this includes data such as: Diesel fill level; condition of spark plugs, coolant temperature, injector position, throttle position, exhaust temperature, fuel pump, etc.

This can be data that is permanently displayed in the vehicle's cockpit. However, it can also be data that is only accessed upon request by the vehicle driver, or data that is only used within the control system as control or regulation data, such as for plausibility checks or error monitoring.

It can also be data that is transmitted from the vehicle by wireless data transmission, such as to an authority, to other vehicles, to traffic infrastructure facilities or to a technical monitoring center for the vehicle.

Provision can be made for the alleged data to be used only to inform the system that all measured values are within the permissible range.

Alternatively or cumulatively, provision can be made for measured values other than those expected by the system to be communicated as alleged (other) measured values. For example, the remaining battery charge can be determined as a measured value and communicated through the data bus as a supposed diesel level.

In this way, display instruments already present in the vehicle can continue to be used.

Furthermore, it is proposed that the data of the communication unit are fictitious values that lie within a standard range, so that these data are processed by the communication units present in the vehicle.

Furthermore, it is proposed that the data of the communication unit be measured values that are provided instead of other data in the network, so that these data are processed by the communication units present in the vehicle.

Furthermore, it is proposed that the control and communication unit receives target specifications from the vehicle and controls the drive unit with the electrically operated motor in such a way that the equivalent behavior is achieved on the shaft.

It is further proposed that the drive unit has an electrically operated heater for generating hot water, and that the drive unit provides hot water to operate the heating systems installed on the vehicle at the request of the vehicle, and that the drive unit provides hot water to replace an auxiliary heater installed on the vehicle at the request of the vehicle. An emulation of the hot water supply of the internal-combustion engine can be achieved by demand-controlled provision of hot water for the unchanged continued operation of the vehicle functions provided by this, in particular a cab heater. An emulation of the hot water supply of an optionally installed, internal-combustion-operated water heater that is independent of the internal-combustion engine can be achieved by providing the hot water on demand for the unchanged continued operation of the vehicle functions provided by this, in particular an auxiliary heater.

Furthermore, it is proposed that the drive unit has an electrically operated heater for generating hot water and uses an optional on-board climate control with automatic timer or remote control to preheat the cab and/or precondition the drive unit and/or the energy sources connected to it (batteries and/or fuel cell system and/or combustion engine external range).

For example, when the ambient air is cool, the battery system can be preheated by the electric heater to a higher starting temperature.

If a timer function is available on the vehicle, the control system proposed here uses the indirect information about the planned departure time to prepare other properties of the vehicle than the temperature in the driver's cab for the most efficient departure possible, in particular to preheat the connected energy sources, especially batteries and fuel cells.

Provision can be made for the vehicle to receive information about when the departure is to take place from a logistics center through a data network, so that the preheating can be activated before a planned departure time even without the timer.

The methods according to the invention and/or the drive unit according to the invention should not be limited to the application and embodiment described above. In particular, the methods according to the invention and/or the drive unit according to the invention can have a number of individual elements, components and units that differs from a number mentioned herein in order to fulfill a function described herein. In particular, the partial use of the expression “at least one” should not be understood to mean that, in the absence of “at least”, only “exactly one” should be proposed. Rather, any indefinite formulation such as “one”, “two”, etc., should always be understood as “at least one”, “at least two”, etc., unless it is clear from the context that only “exactly one”, “exactly two”, etc., is meant.

In addition, for the ranges of values specified in this disclosure, values within the stated limits shall also be deemed to be disclosed and to be usable in any manner.

It should be expressly pointed out that a further aspect of the invention can be described with the following wording:

A method for converting a vehicle from an internal-combustion drive principle to an electrically operated drivetrain by replacing its drive unit, whereby the vehicle belongs to the group of commercial vehicles, special vehicles, mobile work machines and watercraft, whereby the drive unit with an internal-combustion engine has a crankshaft for generating rotary motion, driven by a core engine, whereby the electrically operated drivetrain is set up to perform crankshaft emulation by means of a replacement shaft.

It should also be noted that the features of the independent patent claims can be combined with each other. Therefore, particularly preferential combinations are those made from the group of patent claims 1, 2, 3, 4 and 17.

It is understood that the advantages explained above extend directly to a vehicle, in particular to a commercial vehicle, special vehicle, mobile work machine and/or watercraft, as soon as a drive unit presented here is installed.

Further advantages and optional features of the invention will become apparent from the following description of the drawings. The drawing, the description and the claims contain numerous features in combination. The expert will also expediently consider the features individually and form them into further meaningful combinations.

The drawing shows the only FIGURE in a schematic representation of a method for converting a vehicle.

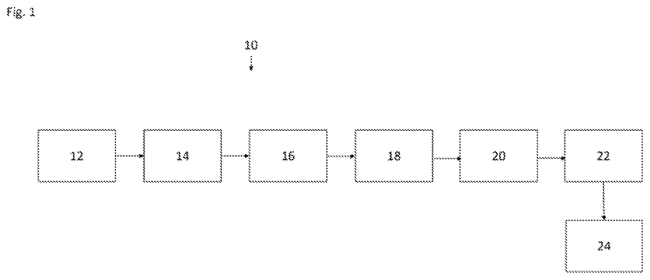

FIG. 1 schematically shows a method 10 for converting a vehicle by replacing the drive unit of the vehicle from an internal-combustion drive principle to an electrically operated drivetrain.

In a method step 12, the drive unit with an internal-combustion engine is mechanically separated from the vehicle and the connections of the auxiliary media.

In a method step 14, the drive unit with an internal-combustion engine and the remaining connected auxiliary units are removed from the vehicle.

In a method step 16, the electrically operated core engine is provided with at least one electrically operated motor, which has a shaft for transmitting rotary movements, and at least one power take-off for transmitting the rotary movements to the drivetrain of the vehicle, and at least one drive-independent power take-off for transmitting rotary movements of the shaft to auxiliary units and a drive engagement of the electrically operated motor to the shaft.

In a method step 20, the electrically operated drive unit is completed and operatively coupled to the auxiliary units, which correspond at least in part to the auxiliary units of the drive unit with an internal-combustion engine, and the drive unit with an electrically operated motor is installed in the vehicle instead of the drive unit with an internal-combustion engine, and the drive unit with an electrically operated motor is operatively coupled to the drivetrain of the vehicle, and the operatively connected auxiliary units are coupled at interfaces to the connections of the auxiliary media present in the vehicle.

In a method step 22, the drive unit with an electrically operated motor is coupled to the minimum of one drive-independent power take-off for transmitting rotary movements of the shaft for work functions.

In other words, the drive unit is removed, the combustion component (core engine) is removed, the electrically operated core engine is installed instead, the auxiliary units are left at least partly identical and at least partly connected to the gear transmission, and the drive unit modified in this way is installed in the vehicle.

In an optional process step 24, a control and communication unit is integrated into the network, receives data from other components of the vehicle and provides data that is read out and/or processed by communication units present in the vehicle.

1. A method for converting a vehicle
by changing its drive unit from an internal-combustion drive principle to an electrically operated drivetrain,
whereby a vehicle for an internal-combustion drive principle has a drive unit with an internal-combustion engine, and whereby a vehicle or an electrically operated drivetrain has a drive unit with an electrically operated motor,
whereby the vehicle belongs to the group of commercial vehicles, special vehicles, mobile work machines and watercraft,
whereby the drive unit with an internal-combustion engine has
a crankshaft for generating rotary motion driven by a core engine, and
at least one main power take-off for transferring the rotary motion to a drivetrain of the vehicle, and
at least one internal power take-off for transferring the rotary motion to unit-internal auxiliary units, and
optionally at least one drive-independent auxiliary power take-off to transfer the rotary motion to external units,
with the following steps:
a. the drive unit with an internal-combustion engine is mechanically separated from the vehicle as follows:
i. Main power take-off: the coupling between the main power take-off and the drive gear is released.
ii. Internal drives connecting the core engine and the auxiliary units: the connection between the auxiliary units and their connections to the rest of the vehicle are separated;
whereby the auxiliary units remain at least partially, preferentially completely, on the unit.
iii. Auxiliary power take-offs: if auxiliary power take-offs are present that lead to external units, they will also be disconnected.
iv. Other connections: all other mechanical, thermal and electro-mechanical connections are unfastened, such as screw joints; hoses and plugs, especially including control connections and the power supply;
so that the drive unit with an internal-combustion engine and the connected auxiliary units are removed from the vehicle and disconnected at a number of interfaces;
b. the drive unit with at least one electrically operated motor is provided as a replacement unit, whereby the replacement unit
i. is spatially compatible with the available installation space of the removed drive unit with an internal-combustion engine and
ii. is mechanically compatible with the interfaces and
iii. behaves functionally identically at all interfaces.

2. A method for converting a vehicle, in particular a method according to claim 1, by replacing its drive unit from an internal-combustion drive principle to an electrically operated drivetrain, whereby a vehicle for an internal-combustion drive principle has a drive unit that has an internal-combustion engine as the core engine, a plurality of gear-driven auxiliary units and a shaft drive, or whereby the vehicle for an electric drive principle has a drive unit with an electrically operated core engine, whereby the vehicle belongs to the group of commercial vehicles, special vehicles, mobile work machines and watercraft,
characterized in that
the drive unit is removed, the combustion component is removed, the electrically operated core engine is installed instead, the auxiliary units are left at least partly identical and are at least partly connected to the gear transmission, and that the drive unit modified in this way is installed in the vehicle.

3. A method for providing a drive unit with an electrically operated motor for a vehicle from the group of commercial vehicles, special vehicles, mobile work machines and watercraft, which can be installed instead of a drive unit with an internal-combustion engine, whereby
the drive unit has a shaft that is designed to act in the same way as a crankshaft of a drive unit with an internal-combustion engine for transmitting rotary movements, whereby
the drive unit has
at least one main power take-off for transferring the rotary motion to a drivetrain of the vehicle, and
at least one internal power take-off for transferring the rotary motion to unit-internal auxiliary units, and
optionally at least one drive-independent auxiliary power take-off to transfer the rotary motion to external units,
whereby the drive unit has an electrically operated motor for driving the shaft, and
the drive unit has an engine mount for attaching the drive unit to the vehicle, which is identical to an engine mount of a drive unit with an internal-combustion engine, and
the drive unit has mechanical connections for attaching the drive unit to a transmission of the vehicle's drivetrain, which connections are identical to those of a drive unit with an internal-combustion engine in terms of fit, and
the drive unit has dimensions that correspond to the dimensions of a drive unit with an internal-combustion engine.

4. A method for converting a vehicle, in particular a method according to claim 1, by changing its drive unit from an internal-combustion drive principle to an electrically operated drivetrain,
whereby a vehicle for an internal-combustion drive principle has a drive unit with an internal-combustion engine or for an electrically operated drivetrain has a drive unit with an electrically operated motor,
the vehicle belongs to the group of commercial vehicles, special vehicles, mobile work machines and watercraft,
whereby the vehicle has a control system by means of which components of the vehicle can exchange data with each other through a network,
characterized in that
a control and communication unit is integrated into the network, receives data from other components of the vehicle and provides data that is read out and/or processed by communication units present in the vehicle.

5. An electrically driven drive unit for installation into a vehicle from the group that includes commercial vehicles, special vehicles, mobile work machines and watercraft, whereby
the drive unit has a shaft for transferring rotary movements, and
the drive unit has an electrically operated motor to drive the shaft,
whereby the drive unit has
at least one main power take-off for transferring the rotary motion to a drivetrain of the vehicle, and
at least one internal power take-off for transferring the rotary motion to unit-internal auxiliary units, and
optionally at least one drive-independent auxiliary power take-off to transfer the rotary motion to external units.

6. A drive unit according to claim 5, whereby the auxiliary power take-off is designed as a live power take-off which is indirectly or directly connected to the shaft and whose speed directly correlates with a speed of the shaft, and/or
the auxiliary power take-off is designed as a transmission power take-off that is connected to the shaft via a transmission, so that the speed of the transmission power take-off can be varied to the same speed as the shaft, and/or
the drive unit has a unit operation for transmitting the rotary movements to at least one auxiliary unit.

7. A drive unit according to claim 5, whereby the unit operation has a roller for transferring the rotary movements to a belt and/or to a timing chain, and whereby, by means of the belt and/or the timing chain, the minimum of one auxiliary unit is indirectly driven by the electric motor.

8. A drive unit according to claim 5, whereby the minimum of one auxiliary unit is a unit from the group comprising a generator, hydraulic pump, power steering pump, water pump, air conditioning compressor, alternator, lubricant pump, coolant pump, metering pump, fan, compressed air generator, brake booster, hydrodynamic permanent brake, electrodynamic permanent brake, vacuum pump and rudder system of a watercraft.

9. A drive unit according to claim 5, whereby the drive unit has drive lubrication for reducing friction between moving drive parts.

10. A drive unit according to claim 5, whereby the drive unit has drive lubrication for heat dissipation from bearing points.

11. A drive unit according to claim 5, whereby the drive lubrication is connected to lubrication of a transmission operatively connected to the drive unit.

12. A drive unit according to claim 5, which has a control and communication unit that provides data that are interpreted as measured values by communication units present in the vehicle.

13. A drive unit according to claim 12, whereby the data of the communication unit are fictitious values that lie within a standard range, so that these data are processed by the communication units present in the vehicle.

14. A drive unit according to claim 12 whereby the data of the communication unit are measured values that are provided instead of other data in the network, so that these data are processed by the communication units present in the vehicle.

15. A drive unit according to claim 12, whereby the control and communication unit receives target specifications from the vehicle and controls the drive unit with the electrically operated motor in such a way that the equivalent behavior is achieved on the shaft.

16. A drive unit according to according to claim 5,
whereby the drive unit has an electrically operated heater for generating hot water, and the drive unit provides hot water to operate the heating systems installed on the vehicle at the request of the vehicle, and the drive unit provides hot water to replace an auxiliary heater installed on the vehicle at the request of the vehicle
and/or
whereby the drive unit thermally conditions the drive unit and the connected energy system for provision of electrical energy upon request from the vehicle's automatic climate control system.

17. A method for converting a vehicle from an internal-combustion drive principle to an electrically operated drivetrain by replacing its drive unit,
whereby the vehicle belongs to the group of commercial vehicles, special vehicles, mobile work machines and watercraft,
whereby the drive unit with an internal-combustion engine has a crankshaft for creating rotary motion, driven by a core engine,
whereby the electrically operated drivetrain is configured to perform crankshaft emulation by means of a replacement shaft.

18. A vehicle comprising a drive unit according to claim 5.
